(19) United States
(12) Patent Application Publication
(10) Pub. No.: US 2003/0206014 A1
(43) Pub. Date: Nov. 6, 2003

(54) Method for designing a selective RF pulse

(75) Inventor: Oliver Heid, Gunzenhausen (DE)

Correspondence Address: SCHIFF HARDIN & WAITE, 6600 SEARS TOWER, 233 S WACKER DR, CHICAGO, IL, 60606-6473, US

(73) Assignee: Siemens Aktiengesellschaft

(21) Appl. No.: 10/428,958

(22) Filed: May 2, 2003

(30) Foreign Application Priority Data
May 2, 2002 (DE) 10219770.9

(51) Int. Cl. G01V 3/00

(52) U.S. Cl. 324/307; 324/309; 324/314

(57) ABSTRACT

In a method for designing a selective RF pulse for a magnetic resonance apparatus, a desired excitation spectrum of the RF pulse is prescribed, a time function is formed by Fourier transformation of the excitation spectrum, a part is selected from the time function that, proceeding from a region around the zero point of the Fourier transformation, extends in a direction, and the selected part is designed to substantially convert to zero at least in the aforementioned region.

### BACKGROUND OF THE INVENTION

1. Field of the Invention

The present invention is directed to a method for designing a selective RF pulse in a magnetic resonance pulse sequence.

2. Description of the Prior Art

Magnetic resonance technology is a known technique for, among other things, acquiring images of the inside of the body of an examination subject. To that end, rapidly switched gradient fields that are generated by a gradient coil system are superimposed on a static basic magnetic field in a magnetic resonance apparatus that is generated by a basic field magnet. The magnetic resonance apparatus also has a radio-frequency (RF) system that emits RF pulses into the examination subject for triggering magnetic resonance signals and picks up the generated magnetic resonance signals, on the basis of which magnetic resonance images are produced.

When the examination subject is exposed to the static, homogeneous basic magnetic field, then atomic nuclei of the examination subject that have a magnetic moment exhibit a resonant frequency that is directly proportional to the strength of the basic magnetic field. If the atomic nuclei of a prescribable isotope that is bonded in a prescribable chemical bond, for example 1H in H₂O, were excited with an RF pulse that exhibits the same frequency as the resonant frequency of these bonded atomic nuclei, then all of these atomic nuclei would exhibit identical resonance and respectively emit undifferentiated magnetic resonance signals that would contain no spatial information as to the distribution of the atomic nuclei in the examination subject.

For a spatially specific magnetic resonance signal, one standard method is to superimpose a magnetic gradient field on the static basic magnetic field in the excitation with RF pulses. As a result, atomic nuclei at different locations along the gradient of the gradient field have different magnetic field strengths exerted thereon and therefore exhibit resonance at different frequencies. A “slice” without any thickness would be excited with a “monochromatic” RF pulse that has only one of the resonant frequencies. However, a thin, three-dimensional cuboid, for example, is desired so that the exciting RF pulse must have a specific bandwidth of neighboring frequencies around its center frequency, so that it can excite the desired, narrow spatial region of the slice thickness along the gradient.

For a more detailed examination of a selective RF pulse, Bloch's equations can be linearized for small excitation angles of RF pulses. It is derived therefrom that the location-dependency of the cross-magnetization along the direction of the gradient applied for selection essentially follows the Fourier transform of the selective RF pulse. In order to obtain an optimally rectangular distribution of the cross-magnetization over the slice thickness, a time dependency corresponding to the sinc function is impressed on the exciting RF pulse, i.e. the sinc function is modulated with the radio-frequency of the RF pulse. The selectivity that can be thus obtained is degraded because, among other things, an infinitely long time duration of course is not available for the transmission of the RF pulse, so that the infinitely long, selective RF pulse can be imagined as being multiplied by a rectangular window function in the time domain, which produces losses in view of the spectral selectivity. Usually, an interval of the RF pulse is transmitted that extends to an equal extent at both sides of the mid-point of the sinc function. The spectral resolution and thus the obtainable selectivity, thus is inverse to the time duration of the RF pulse.

The Abstract of C. T. Mizumoto, “A New Type of asymmetric RF Waveforms Based on Bessel Functions”, Society of Magnetic resonance in Medicine, August 1993, page 1184, describes an asymmetrical RF pulse based on a Bessel function. Sharply defined, rectangular slice profiles can be generated therewith.

### SUMMARY OF THE INVENTION

An object of the invention is to provide a method for designing a selective RF pulse with which a high spectral selectivity can be achieved for an arbitrarily prescribable slice profile given a short duration of the RF pulse.

The object is achieved in accordance with the invention in a method for designing a selective RF pulse for a magnetic resonance apparatus wherein a desired excitation spectrum of the RF pulse is prescribed, a time function is formed by Fourier transformation of the excitation spectrum, a part is selected from the time function that, proceeding from a region around the zero point of the Fourier transformation, extends in a direction, and the selected part is designed to substantially steadily convert to zero at least in the aforementioned region.

Compared to a comparable RF pulse of the same time duration that is designed symmetrically around a zero point of the Fourier transformation, the RF pulse designed according to the inventive method exhibits an increased spectral selectivity. While still having a constant spectral selectivity, the RF pulse designed according to the inventive method can employ a time duration that is roughly half as long, so that more variation possibilities as to the echo time are enabled for pulse sequences, and only a small gradient-time integral is needed for a re-phasing. The design of the RF pulses according to the invention is thus comparable to the effects and advantages achieved with the half-Fourier techniques applied in the acquisition of magnetic resonance signals.

### DESCRIPTION OF THE DRAWINGS

FIG. 1 illustrates a rectangular excitation spectrum of an RF pulse.

FIG. 2 illustrates an unmodulated sinc associated with the excitation spectrum of FIG. 1;

FIG. 3 illustrates a unmodulated time function for an RF pulse of the Prior Art and a rectangular window function.

FIG. 4 illustrates an unmodulated time function as an exemplary embodiment of the invention, and a window function.

### DESCRIPTION OF THE PREFERRED EMBODIMENTS

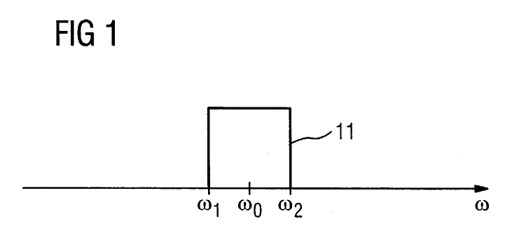

FIG. 1 shows a rectangular excitation spectrum 11 of an RF pulse with limit frequencies ω₁ and ω₂ and a center frequency ω₀ over the frequency ω. The RF pulse with the illustrated excitation spectrum 11 can be utilized for the location-selective excitation of a specific type of atomic nucleus situated in a prescribable chemical bond within a slice of uniform thickness of an examination subject placed in a magnetic resonance apparatus. A static, homogeneous magnetic field is generated with the magnetic resonance apparatus, and a gradient field is superimposed on the basic magnetic field for achieving a spatially selective excitation in the form of the slice with uniform thickness. Only those of the aforementioned atomic nuclei are excited that assume a spatial position with respect to a spatial direction prescribed by the gradient of the gradient field, so that their resonant frequency lies between the limit frequencies ω₁ and ω₂.

An RF pulse with the illustrated excitation spectrum 11 also can be utilized for non-selective (as to location) excitation of different types of atomic nuclei in different chemical bonds within a larger volume, whereby—with only the basic magnetic field being present without a gradient field—only those atomic nuclei are excited which have resonant frequencies between the limit frequencies ω₁ and ω₂.

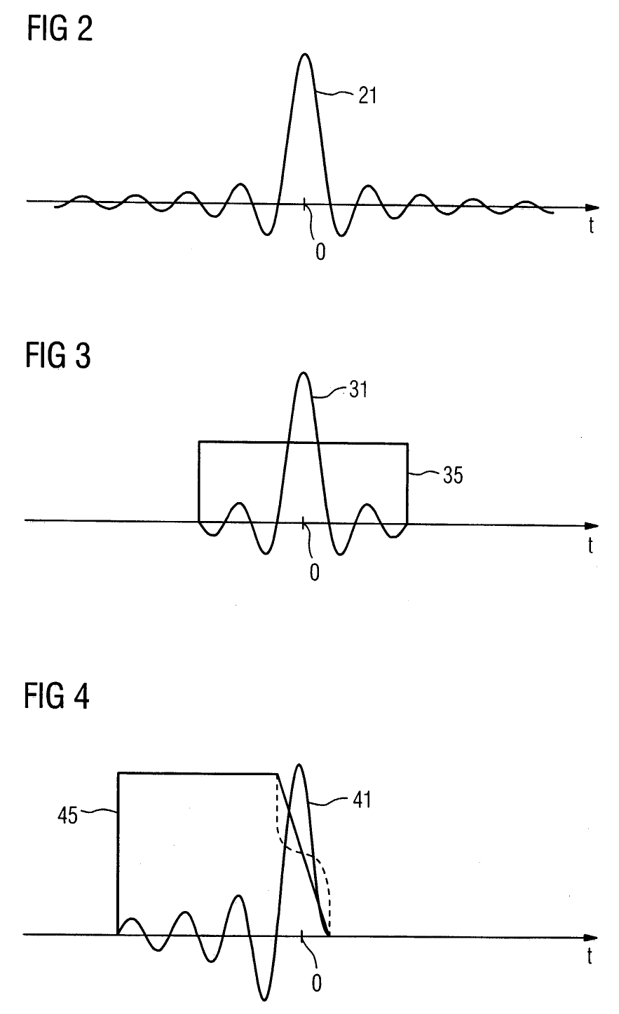

FIG. 2 shows a sinc-time function 21 associated with the excitation spectrum of FIG. 1 over the time t that is derived by Fourier transformation of the excitation spectrum 11, (the modulation with the center frequency ω₀ is not shown, for clarity). The point 0 corresponds to the zero point of the Fourier transformation.

FIG. 3 shown an unmodulated time function 31 for a conventionally designed RF pulse for exciting an approximately rectangular slice profile. The time function of FIG. 3 can be imagined as having arisen from the sinc-time function 21 of FIG. 2 by multiplication thereof with a rectangular window function 35 that is scaled with the factor one and is symmetrical relative to the zero point 0 of the Fourier transformation. The time limitation of the exciting RF function that thereby arises is necessary for achieving reasonable magnetic resonance data and examination times, since the time duration available for the exciting RF pulse given operation of the magnetic resonance apparatus is limited.

As an exemplary embodiment of the invention, FIG. 4 shows a time function 41 for an RF pulse for exciting a rectangular slice profile. One should thereby imagine the time function 41 of FIG. 4 as having arisen from the sinc-time function 21 of FIG. 2 by multiplication thereof with a window function 45 that has a scaling factor of two in its horizontal part that is allocated to secondary lobes of the sinc-time function 21, and that decreases from the scaling factor two to the factor zero in the edge region of the principal lobe of the sinc-time function 21.

An RF pulse based on the time function 41 of FIG. 1 exhibits a spectral selectivity that is about twice as high as an RF pulse based on the time function 31 of FIG. 3, given an identical time duration. The reason for this is that the spectral selectivity is directly proportional to the greater of the distance between the zero point 0 of the Fourier transformation and the beginning of the region wherein the time function 31 is permanently zero, and the distance between the zero point 0 of the Fourier transformation and the beginning of the region wherein the time function 41 is permanently zero.

In order to achieve substantially the same spectral power density for the RF pulse of FIG. 4 compared to the RF pulse of FIG. 3, the window function 45 that causes twice as great a weighting in the majority of the sinc-time function 21, compared to the rectangular window function 35 of FIG. 3, is utilized for generating the time function 41 of FIG. 4. Compared to the RF pulse of FIG. 3, however, the required peak transmission power and the RF pulse energy remain essentially unchanged given the RF pulse of FIG. 4.

Due to the linearly dropping edge of the window function 45, a soft transition of the principal lobe of the time function 41 to zero is achieved, so that discontinuity artifacts are avoided. Instead of the linearly dropping edge shown with the solid line, other Nyquist edges thereby can also be utilized in the window function 45, for example that shown with broken lines.

Although modifications and changes may be suggested by those skilled in the art, it is the intention of the inventor to embody within the patent warranted hereon all changes and modifications as reasonably and properly come within the scope of his contribution to the art.

I claim as my invention:

1. A method for designing a selective RF pulse for use in a magnetic resonance apparatus, comprising the steps of:
prescribing an excitation spectrum for an RF pulse;
forming a time function by Fourier transformation of said excitation spectrum;
selecting a part of said time function proceeding in a direction from a region around a zero point of said Fourier transformation; and
designing said selected part to steadily convert to zero at least in said region.

2. A method as claimed in claim 1 comprising defining said region as extending between two zero points of said time function disposed closest to said zero point of said Fourier transformation.

3. A method as claimed in claim 1 comprising selecting said region to extend symmetrically around said zero point of said Fourier transformation.

4. A method as claimed in claim 1 comprising selecting said part to extend in a negative direction.

5. A method as claimed in claim 1 comprising designing said selected part to convert to zero in said region at least once in a differentiatable fashion.

6. A method as claimed in claim 1 comprising designing said part by multiplying said time function in said region by a Nyquist function.

7. A method as claimed in claim 6 comprising employing a Nyquist function with a linearly decreasing Nyquist edge.

8. A method as claimed in claim 1 comprising scaling said selected part of said time function in amplitude.

9. A method as claimed in claim 1 comprising prescribing a rectangular excitation spectrum, and forming a modulated sinc-time function as said time function.

10. A selective RF pulse for a magnetic resonance apparatus designed according to claim 1.
